(19) United States
(12) Patent Application Publication
(10) Pub. No.: US 2019/0061133 A1
(43) Pub. Date: Feb. 28, 2019

(54) MULTIPURPOSE SCORING AND PRYING TOOL

(71) Applicant: Jarrett Kellan, Appleton, WI (US)

(72) Inventor: Jarrett Kellan, Appleton, WI (US)

(21) Appl. No.: 15/689,613

(22) Filed: Aug. 29, 2017

(51) Int. Cl. B25F 1/00; B66F 15/00; B26B 5/00

(52) U.S. Cl. CPC B25F 1/00; B26B 5/005; B66F 15/00

(57) ABSTRACT

A tool with a broad rigid metal blade with a bend and a handle, with a broad flat region for insertion between 2 pieces. The tool blade has a sharp bevel inside a bend. The tool also includes a rounded scoring point for scoring paint or putty before prying without marring the underlying surface.

### FIELD OF THE INVENTION

This disclosure relates to a hand tool used for scoring and removal of trim.

With current tools, it is difficult to separate parts such as trim from a wall without marring the wall or scraping knuckles while trying to insert the tool.

### SUMMARY OF THE INVENTION

Disclosed is a tool with a broad rigid metal blade with a bend and a handle, with a broad flat region for insertion between 2 pieces. The tool also includes a sharp bevel inside a bend. The tool also includes a rounded scoring point for scoring paint or putty before prying without marring the underlying surface. In one embodiment, the tool handle has an Impact butt end for applying a strong force to the tool, such as by a hand.

The tool helps with the removal of putty and window glaze, and helps to separate or remove trim, and pry, scrape, or score with little or no damage, marring or breaking of glass or wall.

### BRIEF DESCRIPTION OF THE DRAWINGS

FIG. 1 is a top view of a blade portion of a preferred embodiment, of the disclosure.

FIG. 2 is a side perspective view of another embodiment of a tool according to this disclosure.

FIG. 3 is side view of the blade portion of FIG. 1.

### DETAILED DESCRIPTION

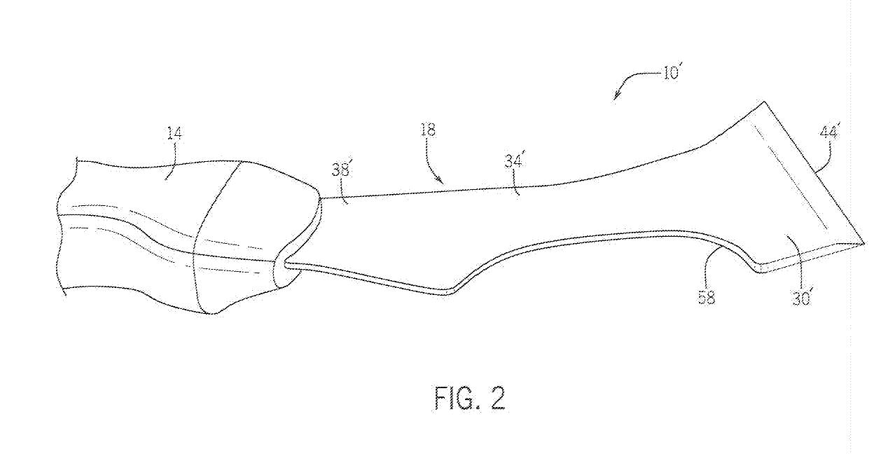

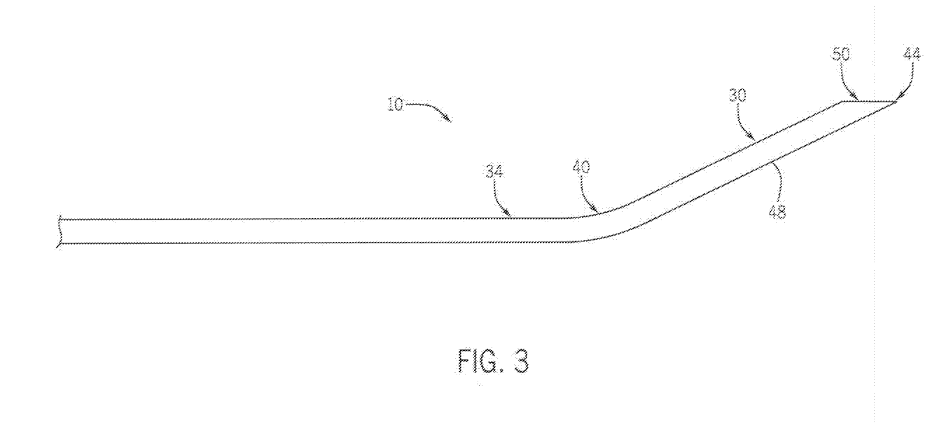

Disclosed in the drawings is a hand tool 10 comprising a handle 14, and a blade 18 having a distal end 22 and a center line 26 extending longitudinally along the blade 18 from the handle 14 to the distal end 22. The blade 18 is made of a rigid material about 2 mm in depth, as shown in FIGS. 2 and 3.

The blade 18 has a distal portion 30, a middle portion 34 connected to the distal portion 30, and a base portion 38 connected to the middle portion 34 and to the handle 14. The middle portion has a bend 40 extending perpendicular to the center line 26, the bend 40 being of between 20 and 45 degrees. The middle portion 34 is spaced no more than 1.5 inches from the distal end 22 of the blade 18.

The distal portion is substantially flat and forms a convex quadrilateral, with a narrower side of the convex quadrilateral being connected to the blade middle portion and a wider side of the convex quadrilateral being at the distal end.

The distal end has a sharp edge 44, and a flat side 48 outside the bend and a bevel 50 on the inside of the end. Sharp edge, as used herein, means the edge is tapered down to a point. In one embodiment, the bevel 50 is substantially parallel to the handle, as shown in FIG. 3, and a rounded scoring corner 54 is formed between at least one side of the quadrilateral and the distal end of the quadrilateral. The width of the distal end 22 is at least 2 inches and the middle portion 34 is between ⅞ths of an inch and no more than 1.5 inches from the distal end 22 of the blade.

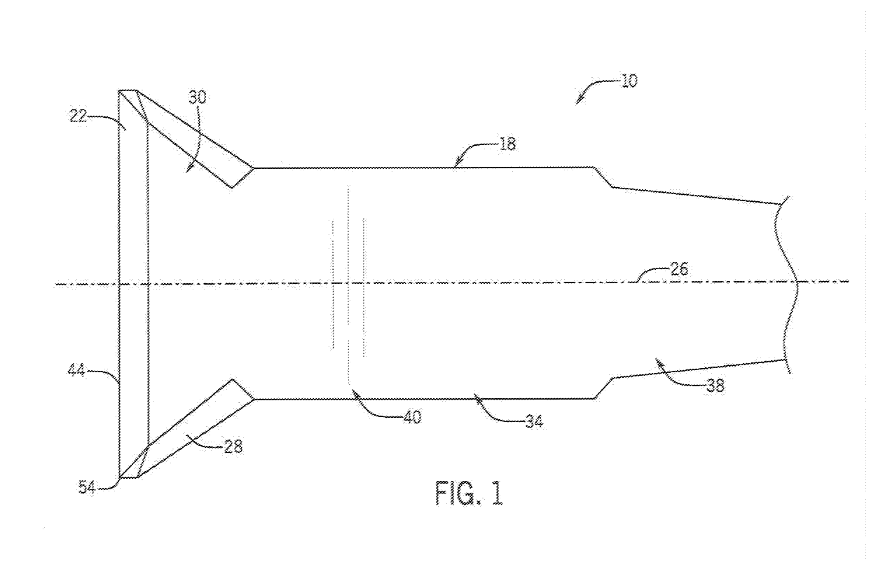

In one embodiment, the width of the middle portion 34 perpendicular to the center line 26 is about 1.5 inches, and the width of the distal end 22 perpendicular to the center line 26 is about 2.5 inches. The handle 14 is made of plastic and has an impact blunt end (not shown) opposite the handle connection to the blade 18. In other embodiments (not shown), the handle 14 can be made of other materials, such as wood, hard rubber or metal. In one embodiment, one side of the middle portion has a crescent shaped cutout 58, as shown in FIG. 2, but in the preferred embodiment, as shown in FIG. 1, the blade 18 is symmetrical on either side of the center line 26. Like components in tool 10 in FIGS. 1 and 3 and tool 10′ in FIG. 2 have the same numbering, only with an apostrophe.

In one embodiment, the distal portion 30 is a trapezoid, and more particularly, the distal portion 30 is an isosceles trapezoid. One 28 of the sides of the quadrilateral not connected to the middle section has a sharp edge, and the blade 18 is symmetrical on either side of the center line 26, as shown in FIG. 1. In the disclosed embodiment, both sides of the, distal portion 30 has a sharp edge.

In FIG. 1, the tool 10 is seen from the top. The steel blade 18 contains a 20-45 degree bend located 1-1.5 inches from the distal end 22. These features allow easy insertion between parts such as wood trim and a wall without scraping the workers knuckles. A smooth pulling or leveraging motion separates parts such as trim (not shown) without marring the wall (not shown). There is also the rounded corner 54 on one side of the distal end of the tool that is used for scoring of paint or putty. In the embodiment shown in FIG. 2, the blade 18 includes the circular design 58 for scraping paint rollers, but this feature is not a required element of this tool.

More particularly, the tool blade 18 is made of tempered spring steel no greater than 2 mm at the distal end 22 to the bend 40. Spring tempering is a temper induced in steel to increase its upper limit of elasticity by hardening and tempering in the ordinary way and then reheating until the steel assumes a particular color. These steels are generally low-alloy, medium-carbon steel or high-carbon steel with very high yield strength. Materials with properties similar to tempered steel can also be used.

The proportions of this tool 10 are important to its function. For example, a prototype with a 20 degree bend 1.5″ from the distal end and the tool did not work. It was discovered that the lesser the degree of the bend, the closer it needs to be to the distal end.

Another prototype with a 45-degree bend about 1.25″ from the distal end and that tool actually worked just as well as the 25 degree tool except for when hitting it with a hammer. It was found that having several of these tools with different bends serves uses better than just one tool.

Additionally, as long as one stays within a certain set of parameters regarding the angle of the bend, the distance of the bend from the distal end, the sharp distal end edge, and the width of the tool, then this tool can be scaled larger or smaller to suit various needs. Once one strays from these parameters the tool becomes less useful.

For example, with a tool with a 25-degree bend about 1″ from the distal end having a blade that is only ¾″ wide, there would not be enough leveraging force to offer a good prying function. Neither would it offer enough distribution on the surface to prevent marring of the prying surface.

There are 3 parameters (in terms of ratio or proportionality) that set the, boundaries for the functionality of this tool:

1. degree of bend;

2. distance of bend from distal end; and

3. width of prying surface.

The closer the bend to the distal end, then the wider the flat prying surface “should” be in order to keep a similar proportion with the prying surface.

This tool is configured in such a way that if one of the defining characteristics is removed or modified, there is a significant loss, of function of the tool. It should be noted that changing or eliminating any one of these four characteristics changes the function of the tool.

Once the tool meets these characteristics, several other features may be added such as the angled scoring/cutting edges, a nail pulling slot, etc., however, these features are merely added utilities and are not critical to the overall functionality of the tool.

I have not found a better tool that exists on the market today to perform most of the activities listed below.

A. Glass & Glazing Industry
1. Removal of vinyl snap-in glazing bead—best possible tool.
a. Sharp edge gets into tight seam between bead & sash.
b. Inside bevel combined with 20 degree bend provides leverage to pry without damaging vinyl.
c. The sharp bevel also acts as silicone cutting tool to cut through sealants used in glazing.
d. The sharp point gets into sash corners for cutting sealants.
e. Broad pressing surface allows for use of force while minimizing glass breakage risk.
2. Removal of wood interior stops & glazing bead
a. All of the above
b. Sharp point allows for scoring paint/varnish build up between sash and wood bead or trim
3. Glass removal from sash.
a. Thin, tool (2 mm) allows for tool to be pushed between sash and glass and large pressing surface allows for prying glass out of sash while minimizing breakage.
4. Removal of exterior aluminum glazing stops.
a. Same as 3.a. above
b. This tool used first creates a space between the glazing bead and the glass so that a larger 90 degree bar can be used for final leverage to “pop” bead out of retainer. This tool is also then used as a prying surface for the larger pry bar to avoid glass breakage.
5. Traditional single pane glass glazing.
a. Tool can be used optimally to remove old dried glazing putty.
b. Best tool for removing old glaziers points—traditionally a flat screw driver or stiff putty knife is used; however neither of these provides the best leverage without a bend and the tip of the screwdriver is often too thick to get into a tightly seated glazier's point.
c. sharp edges can then be used to clean sash edges—scraping out old putty after glazier's points are removed.
d. Angled, edge can be used to create 45 degree chamfer while applying new putty.

B. Trim Removal—Finish Carpentry & Remodeling
1. Sharp angled point can be used to score paint, varnish, and caulked seams. Large flat surface allows the user to run the tool flat to the wall while doing this, creating a uniform score along the trim piece.
2. Inside bevel and the mild bend create high activation energy to create initial separation from trim and wall (or whatever surface it is nailed to).
3. Large flat surface allows use of significant force for separation before causing damage to finished surface.
4. Can be used ergonomically to pry in either direction (unlike a traditional pry bar). Often, when a piece of trim is fastened with large nails it is better to “punch” the tool into the seam (this creates the needed activation energy for the initial separation), then slide the tool deeper and pull the handle towards you (instead of prying away). This creates just as much leverage but places the fulcrum (point of contact) behind the trim so any damage that may occur is covered when the trim is reinstalled. This is also true for removing wood trim stops from windows.
5. Is an excellent “assist” tool when used in conjunction with traditional pry bars.
a. creates the initial separation without damage so larger tool can be fit into the seam for more extreme prying.
b. provides an effective and ergonomic scoring edge even when the trim to be removed is too large for this tool to be used as a pry bar.
c. provides a broad surface for a larger pry bar to leverage against so you can protect the finished surface.
d. is an excellent scraper for removing old sealants once the trim piece has been removed.
6. The blunt end can be hit with a hammer or mallet; however, the sharp edge combined with the 20 degree bevel often allows (more often than not) for merely a sharp hit with the palm of your hand to penetrate the seam and create the initial separation so that the tool can then be used as a pry bar to complete the removal process.

C. Scraping
1. The bend in the tool is approx. 20 degree and the bevel is also approx. 20 degree. This allows for an ergonomic, safe, and highly effective way to scrape sealants from flat surfaces.
2. The angled point allows for scraping hard to reach surfaces and odd angles
3. The slightly rounded edges allows for scraping walls fast and aggressively without risking a sharp corner to gouge the wall (such as in scraping wall paper—this tool is the best for this!)

D. Cutting & Chiseling—While not taking the place of a knife, this tool can cut open boxes (tape) or be used for cutting duct tape, small rope, and string. It can also be used in lieu of a chisel. This tool is convenient for these uses in a pinch although not necessarily the best tool for cutting and/or chiseling.

Various other features of this disclosure are set forth in the following claims.

1. A hand tool comprising:
a handle, and
a blade having a distal end and a center line extending longitudinally along the blade from the handle to the distal end, the blade being made of rigid material about 2 mm in depth, the blade has
a distal portion, a middle portion connected to the distal portion, and a base portion connected to the middle portion and to the handle,
the middle portion having a bend extending perpendicular to the center line, the bend of between 20 and 45 degrees,
the distal portion being substantially flat and forming a convex quadrilateral, with a narrower side of the convex quadrilateral being connected to the blade middle portion and a wider side of the convex quadrilateral being at the distal end, the distal end having a sharp edge, and a flat side outside the bend and bevel on the inside of the end, the bevel being substantially parallel to the handle, and a rounded scoring corner formed between at least one side of the quadrilateral and the distal end of the quadrilateral, the width of the distal end being at least 2 inches and the depth of the middle portion being between ⅞ths of an inch and no more than 1.5 inches from the distal end of the blade.

2. The hand tool according to claim 1 wherein the width of the middle portion perpendicular to the center line is about 1.5 inches.

3. The hand tool according to claim 1 wherein the width of the distal end perpendicular to the center line is about 2.5 inches.

4. The hand tool according to claim 1 wherein the handle is made of plastic and has an impact blunt end opposite the handle connection to the blade.

5. The hand tool according to claim 1 wherein the blade is made of tempered steel.

6. The hand tool according to claim 1 wherein at least one of the sides of the quadrilateral not connected to the middle section has a sharp edge.

7. The hand tool according to claim 1 wherein the blade is symmetrical on either side of the center line.

8. A hand tool comprising:
a blade having a distal end and a center line extending longitudinally along the blade from the handle to the distal end, the blade being made of rigid material, the blade has
a distal portion, a middle portion connected to the distal portion, and a base portion connected to the middle portion,
the middle portion having a bend extending perpendicular to the center line, the bend of between 20 and 45 degrees,
the distal portion being substantially flat and forming a shape having at least four sides, with a first side of the shape being connected to the blade middle portion and an opposite side of the shape being at the distal end, the distal end having a sharp edge, and a flat side outside the bend and bevel on the inside of the end, the width of the distal end being at least 1 inches and the depth of the middle portion being between ⅞ths of an inch and no more than 1.5 inches from the distal end of the blade.

9. A hand tool comprising:
a handle, and
a blade having a distal end and a center line extending longitudinally along the blade from the handle to the distal end, the blade being made of rigid material about 2 mm in depth, the blade has
a distal portion a middle portion connected to the distal portion, and a base portion connected to the middle portion and to the handle,
the middle portion having a bend extending perpendicular to the center line, the bend of between 20 and 45 degrees,
the distal portion being substantially flat and forming a convex quadrilateral, with a narrower side of the convex quadrilateral being connected to the blade middle portion and a wider side of the convex quadrilateral being at the distal end, the distal end having a sharp edge, and a flat side outside the bend and bevel on the inside of the end, the bevel being substantially parallel to the handle, and a rounded scoring corner formed between at least one side of the quadrilateral and the distal end of the quadrilateral, the width of the distal end being at least 2 inches and the depth of the distal end being between 7/8ths of an inch and no more than 1.5 inches from the distal end of the blade.
wherein the width of the middle portion perpendicular to the center line is about 1.5 inches, the width of the distal end perpendicular to the center line is about 2.5 inches, the handle is made of plastic and has an impact blunt end opposite the handle connection to the blade, the blade is made of tempered steel, at least one of the sides of the quadrilateral not connected to the middle section has a sharp edge, and the blade is symmetrical on either side of the center line.
